(19) United States
(12) Patent Application Publication
(10) Pub. No.: US 2025/0329119 A1
(43) Pub. Date: Oct. 23, 2025

(54) VIRTUAL OBJECT DISPLAY DEVICE AND VIRTUAL OBJECT DISPLAY METHOD

(71) Applicant: Maxell, Ltd., Kyoto (JP)

(72) Inventors: Nobukazu KONDO, Kyoto (JP); Yasunobu HASHIMOTO, Kyoto (JP); Mayumi NAKADE, Kyoto (JP); Hitoshi AKIYAMA, Kyoto (JP); Naohisa TAKAMIZAWA, Kyoto (JP); Masuo OKU, Kyoto (JP)

(21) Appl. No.: 18/869,945

(22) PCT Filed: May 30, 2022
(86) PCT No.: PCT/JP2022/021884

§ 371 Date: Nov. 27, 2024

(51) Int. Cl. G06T 19/00

(52) U.S. Cl. CPC G06T 19/006; G06T 2219/024

(57) ABSTRACT

A virtual object display method includes: a map information processing step of extracting a first map element corresponding to position information and a second map element corresponding to a predetermined pattern from map data; a virtual object processing step of disposing a virtual object on a real object in a real space corresponding to the first map element; an auxiliary information processing step of generating a map element object corresponding to the second map element; a display processing step of drawing portions, which are located in front of and behind the real object, in the virtual object and the map element object using different drawing methods; and a display step of displaying the virtual object and the map element object processed in the display processing step to be superimposed on the real space.

### TECHNICAL FIELD

The present invention relates to a virtual object display device, such as a head mounted display, and a virtual object display method.

### BACKGROUND ART

A mixed reality (MR) technology which displays a virtual object created by computer graphics (CG) to be superimposed on a real space is widely used in games, sports, remote medical care, maintenance work, and the like.

Examples of a virtual object display device include information processing devices such as head mounted displays (HMDs), head-up displays (HUDs) mounted on vehicles and airplanes, car navigation systems, and smartphones.

In the MR technology, for example, in the case of the HMD, a virtual object that is drawn to be superimposed on an image of a real space seen through a display unit according to the movement of the HMD or the like is displayed as an image of a virtual space on the display unit. Alternatively, in the HMD, an image of a real space captured by a camera and a virtual object are displayed on a non-transmissive reflective display unit to be superimposed on each other.

Patent Document 1 is a background art in this technical field. Patent Document 1 discloses that a user of an HMD is a runner and the HMD displays a virtual object which is a virtual runner to enhance the sense of realism of running and to enable the user to easily understand information related to running.

### CITATION LIST

### Patent Document

Patent Document 1: JP 2011-67277 A

### SUMMARY OF THE INVENTION

### Problems to be Solved by the Invention

In the MR technology, occlusion processing that compares a distance between a user and a real object in a real space with a distance between the user and a virtual object and hides a portion of the virtual object having a positional relationship farther than the real object is performed to achieve a three-dimensional view. Therefore, in a case where the entire virtual object is hidden, the user is not able to view the virtual object.

Patent Document 1 has a problem that, in a case where a situation in which the user is not able to view the virtual object continues, the user is not able to recognize the virtual runner for a long period of time, which makes it difficult to achieve the purpose of enhancing the sense of realism. As described above, in Patent Document 1, a technique that responds to the situation in which the virtual object is invisible due to the occlusion processing on the real object is not considered.

The present invention has been made in view of the above, and an object of the present invention is to provide a virtual object display device and a virtual object display method that can enhance a sense of realism of a user even in a situation in which a virtual object is invisible.

### Solutions to Problems

According to an aspect of the present invention, there is provided a virtual object display method including: a map information processing step of extracting a first map element corresponding to position information and a second map element corresponding to a predetermined pattern from map data; a virtual object processing step of disposing a virtual object on a real object in a real space corresponding to the first map element; an auxiliary information processing step of generating a map element object corresponding to the second map element; a display processing step of drawing portions, which are located in front of and behind the real object, in the virtual object and the map element object using different drawing methods; and a display step of displaying the virtual object and the map element object processed in the display processing step to be superimposed on the real space.

### Effects of the Invention

According to the present invention, it is possible to provide a virtual object display device and a virtual object display method that can respond to a situation in which a virtual object is invisible and can enhance a sense of realism of a user.

### BRIEF DESCRIPTION OF THE DRAWINGS

FIG. 1A is a diagram illustrating an external configuration of an HMD according to an embodiment.

FIG. 1B is a diagram illustrating an external configuration of another HMD according to the embodiment.

FIG. 2 is a functional block diagram illustrating the HMD according to the embodiment.

FIG. 3 is a diagram illustrating a hardware configuration of the HMD according to the embodiment.

FIG. 4 is a flowchart illustrating MR processing according to the embodiment.

FIG. 5 is a flowchart illustrating a virtual object generation process according to the embodiment.

FIG. 6 is a flowchart illustrating a virtual object disposition process according to the embodiment.

FIG. 7 is a flowchart illustrating a course object generation process according to the embodiment.

FIG. 8 illustrates an example of display of a visible virtual object according to the embodiment.

FIG. 9 illustrates an example of display of the virtual object in a case where the virtual object is invisible in the embodiment.

FIG. 10 illustrates an example in which the virtual object is disposed at a specific position in the embodiment.

FIG. 11 illustrates an example of display in a case where the virtual object is behind a user in the embodiment.

FIG. 12 illustrates an example of display in a case where the virtual object is out of a visible range in the embodiment.

### MODE FOR CARRYING OUT THE INVENTION

Hereinafter, an embodiment of the present invention will be described with reference to the drawings. In addition, in this embodiment, an HMD will be described as an example of a virtual object display device.

### Embodiments

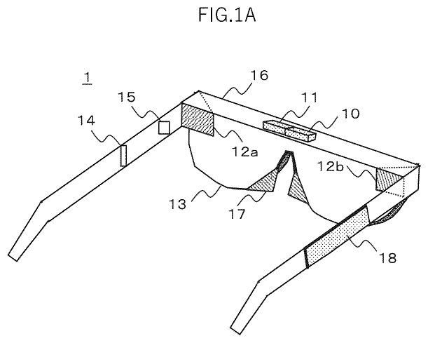

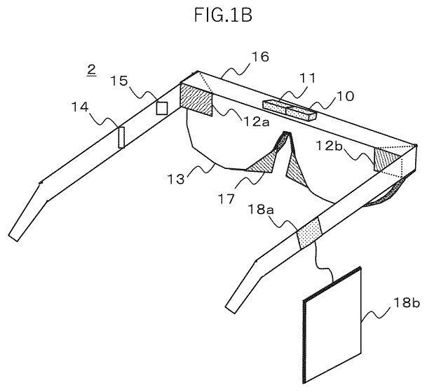

FIG. 1A is a diagram illustrating an external configuration of the HMD according to this embodiment. In FIG. 1A, 1 indicates the HMD, 10 indicates a camera, 11 indicates a distance measurement sensor, 12a and 12b indicate a pair of left and right projection units (projectors), 13 indicates a semi-transmissive screen, 14 indicates a speaker, 15 indicates a microphone, 16 indicates a housing, 17 indicates a support portion, and 18 indicates a control unit.

A user of the HMD 1 wears the HMD 1 on his or her face using the housing 16 and the support portion 17. The camera 10 images a real space in front of the HMD 1, and the distance measurement sensor 11 measures a distance between the HMD 1 and a real object in the real space imaged by the camera.

The projection units 12a and 12b and the screen 13 constitute a display unit of the HMD 1. The projection units 12a and 12b project an image of the virtual object to be seen by the left eye and an image of the virtual object to be seen by the right eye onto the screen 13, respectively, to three-dimensionally display the virtual object, which is a projection image, as if the virtual object is at a predetermined distance in the real space.

In addition, in this embodiment, an optical see-through type that allows the user of the HMD to see the image of the real space in front of the user through the screen 13 will be described as the HMD. However, the HMD may also be a video see-through type in which the image of the real space captured by the camera is projected onto the screen 13 to be seen by the user.

Here, in the display of the HMD, occlusion processing is performed in an anteroposterior relationship between the distances of the real object and the virtual object. The occlusion processing is a process that, in a case where a portion of the real object is in front of a portion of the virtual object, processes drawing data of the virtual object such that the portion of the virtual object is hidden by the portion of the real object, and an image of an MR space with depth is displayed by the occlusion processing.

The control unit 18 acquires the image of the real space captured by the camera 10 and supplies the image to a memory or a CPU provided therein. In addition, the HMD 1 is provided with a sensor group including a GPS, a gyro, a direction sensor, and an acceleration sensor, and the control unit 18 detects the position and movement of the HMD on the basis of information from the sensor group. Further, the control unit 18 creates images to be projected by the projection units 12a and 12b and sounds to be output to the speaker 14. The control unit 18, the camera 10, the distance measurement sensor 11, the speaker 14, and the microphone 15 are disposed in the housing 16. In addition, the disposition locations of these components are not limited to those illustrated in FIG. 1A.

FIG. 1B is a diagram illustrating an external configuration of another HMD according to this embodiment. In FIG. 1B, the same functions as those in FIG. 1A are denoted by the same reference numerals, and a description thereof will be omitted. FIG. 1B differs from FIG. 1A in that the control unit 18 is divided into 18a and 18b.

In FIG. 1B, the control unit 18a and the control unit 18b are connected by a wired or wireless interface. The control unit 18b is, for example, a general-purpose information terminal such as a smartphone or a smart watch. With the configuration of the HMD 2 illustrated in FIG. 1B, a portion of the control unit 18 illustrated in FIG. 1A may be provided as the control unit 18a, which has the advantage that it is possible to reduce the size and weight of the HMD 2.

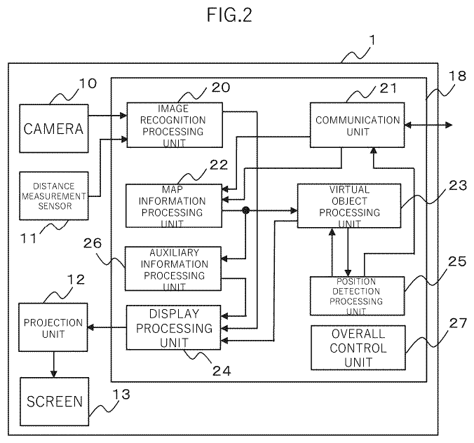

FIG. 2 is a functional block diagram illustrating the HMD according to this embodiment. FIG. 2 illustrates the case of the HMD 1 illustrated in FIG. 1A and particularly illustrates the details of the functional block diagram of the control unit 18. In addition, the same blocks as those illustrated in FIG. 1A are denoted by the same reference numerals, and a description thereof will be omitted. Further, the projection units 12A and 12B illustrated in FIG. 1A are collectively described as a projection unit 12, and the microphone, speaker, and the like are omitted.

In FIG. 2, the control unit 18 has an image recognition processing unit 20, a communication unit 21, a map information processing unit 22, a virtual object processing unit 23, a display processing unit 24, a position detection processing unit 25, an auxiliary information processing unit 26, and an overall control unit 27.

The position detection processing unit 25 includes a GPS, a direction sensor, a gyro sensor, and the like and detects the position and orientation of the HMD. The overall control unit 27 obtains the distance between the HMD (=the user) and a virtual object (=a competitor) calculated by the virtual object processing unit 23 on the basis of the information detected by the position detection processing unit 25. Then, the overall control unit 27 designates a position and a range to a map data server (not illustrated) through the communication unit 21 on the basis of the information and transmits a download request. Map data downloaded by the communication unit 21 is input to the map information processing unit 22.

The map information processing unit 22 extracts a map element, such as a road, which is set in advance as a running course from the map data and outputs the map element as extracted information to the virtual object processing unit 23. In addition, the map information processing unit 22 stores data of the course through which the user plans to run or obtains the data through the communication unit 21 and uses the data to extract the map element from the map data.

The image recognition processing unit 20 receives the camera image of the camera 10 and the distance data of the distance measurement sensor 11 as: inputs, recognizes real objects, such as roads and buildings, from the real space captured by the camera image, and assigns the distance data to feature points of the real objects.

The virtual object processing unit 23 calculates the position of the competitor on the basis of running pace information of the competitor and generates image data of the virtual object. The image data of the virtual object may be obtained from an external server via the communication unit 21. In addition, the virtual object processing unit 23 obtains the current position of the user from the position detection processing unit 25 and disposes the virtual object according to the extracted information such as the running course. Further, the position of the virtual object is sent to the position detection processing unit 25 to determine the range of the map data to be downloaded. The download range of the map data changes from moment to moment. A difference from the range that has already been downloaded can be updated to suppress an increase in the amount of downloaded data.

The auxiliary information processing unit 26 performs, for example, a process of generating a course object of auxiliary information based on the course data from the extracted information such as the running course. In addition, the display processing unit 24 receives the course object from the auxiliary information processing unit 26, the virtual object from the virtual object processing unit 23, and the real object from the image recognition processing unit 20 as inputs, performs the occlusion processing among the virtual object, the course object, and the real object and sends a virtual object image and a course object image to the projection unit 12 to be displayed on the screen 13.

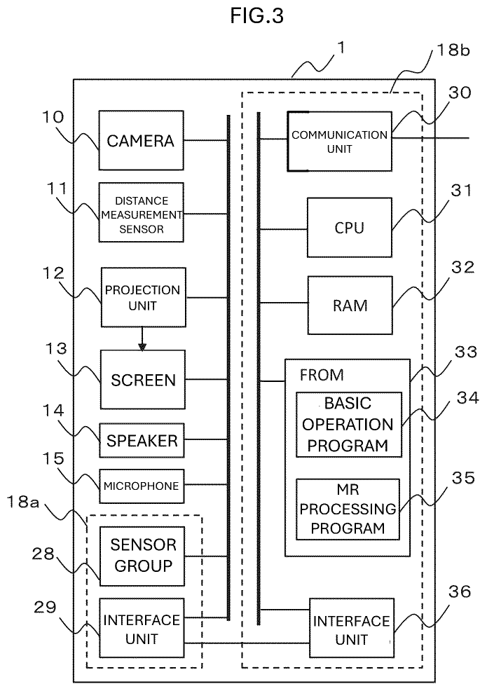

FIG. 3 is a block diagram illustrating a hardware configuration of the HMD according to this embodiment and illustrates the case of the HMD 1 illustrated in FIG. 1A. In FIG. 3, the same blocks as those illustrated in FIG. 1A are denoted by the same reference numerals, and a description thereof will be omitted. In addition, the control unit 18 is divided into the control units 18a and 18b illustrated in FIG. 1B.

In FIG. 3, the control unit 18a includes a sensor group 28 including the GPS, the direction sensor, the gyro sensor, and the like and an interface unit 29, and the control unit 18b includes a communication unit 30, a CPU 31, a RAM 32, a flash ROM (FROM) 33, and an interface unit 36.

The communication unit 30 of the control unit 18b selects an appropriate process from several communication processes including mobile communication systems, such as 4G and 5G, and a wireless LAN, connects the HMD to a network, and downloads the map data and the like from an external server. In addition, the FROM 33 includes a basic program 34 and an MR processing program 35 as processing programs. These processing programs are deployed in the RAM 32, and the CPU 31 performs software processing to implement various functions illustrated in FIG. 2. Further, data required to execute the processing programs is stored in the FROM 33. The FROM 33 may be a single memory medium as illustrated in the figure or may be configured by a plurality of memory media. Furthermore, the FROM 33 may be a non-volatile memory medium other than the flash ROM.

Moreover, in FIG. 3, in the case of the configuration of the HMD 1 having the control unit 18 obtained by integrating the control units 18a and 18b illustrated in FIG. 1A, the interface units 29 and 36 may not be provided.

In addition, in the case of the configuration illustrated in FIG. 1B in which the control unit 18 is divided into the control units 18a and 18b, in FIG. 3, the control unit 18b is separated from the HMD, and the control units 18a and 18b are connected by the interface units 29 and 36. In this case, the interface units 29 and 36 may be wired interfaces, such as USBs (registered trademark), or may be wireless interfaces such as a wireless LAN and Bluetooth (registered trademark). As described above, in the configuration in which the control unit 18 is divided into the control units 18a and 18b, the HMD may be provided with only the control unit 18a which is a portion of the control unit 18, which makes it possible to reduce the size and weight of the HMD.

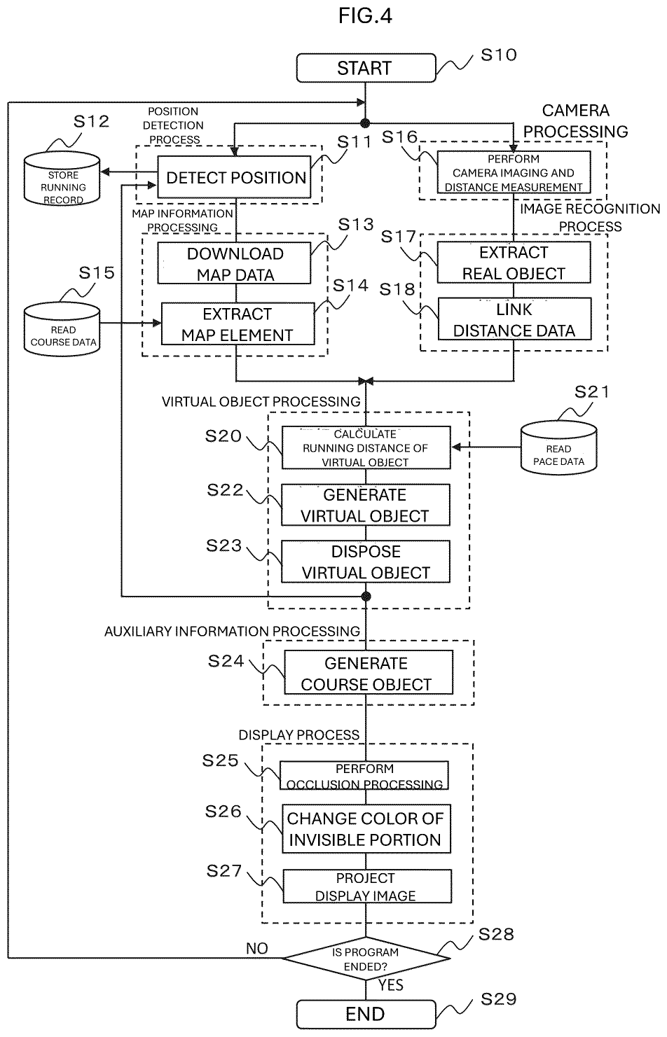

FIG. 4 is a flowchart illustrating MR processing according to this embodiment. In FIG. 4, the process starts in Step S10, and Step S11 is a position detection process of the position detection processing unit 25 described with reference to FIG. 2. In Step S11, the current position of the HMD is detected on the basis of the data from the sensor group 28, and a request to download the map data is output together with the position of the virtual object which will be described below. Further, in Step S12, the current position of the HMD and the position of the virtual object are stored as a running record at regular time intervals.

Steps S13 to S15 are map information processing of the map information processing unit 22 described with reference to FIG. 2. Map data is downloaded in S13, course data is read in S15, and roads and the like set as the running course are extracted as map elements with reference to the course data read in S14.

Step S16 is a step of performing camera imaging and measuring a distance in a camera processing unit and acquires a camera image and distance data.

Steps S17 and S18 are an image recognition process of the image recognition processing unit 20 described with reference to FIG. 2. In S17, a real object, such as a road or a building, is recognized from the camera image which is the image of the real space. In S18, the distance data is linked to a feature point of the recognized real object.

Steps S20 to S23 are virtual object processing of the virtual object processing unit 23 described with reference to FIG. 2. In S21, the stored running pace data is read. In S20, the running distance of the virtual object is calculated. In S22, an image of the virtual object (=a competitor) is generated. The size of the image of the virtual object changes depending on a viewing distance from the HMD, and the orientation of the image changes depending on the direction of the HMD. In addition, in S23, the virtual object is disposed on the road of the extracted running course. Further, the disposition position of the virtual object is sent to the position detection process S11 to determine the range of the map data to be downloaded.

Step S24 is auxiliary information processing of the auxiliary information processing unit 26 described with reference to FIG. 2, in which a course object (=an auxiliary information object) corresponding to the extracted running course is generated. The course object is an object that indicates the road along the running course and may be a three-dimensional object in which the distance data has been reflected. In addition, as the auxiliary information object, a distance information object indicating numerical data of distance information may be given as a milestone. Further, in a case where the competitor is present outside the viewing angle range of the user, a pseudo course object may be generated instead of the course object. The pseudo course object may be an object in which only the sense of distance to the competitor has been reflected. Furthermore, since the course object, the distance information object, the pseudo course object, and the like are objects related to the map, they are also referred to as map element objects.

Steps S25 to S27 are a display process of the display processing unit 24 described with reference to FIG. 2. In S25, the occlusion processing between the real object and the virtual object (also including the course object) is performed. In the occlusion processing, the distance between the user and the real object in the real space is compared with the distance between the user and the virtual object to distinguish a portion of the virtual object having a positional relationship closer than the real object from a portion of the virtual object having a positional relationship farther than the real object.

The portion of the virtual object having the positional relationship farther than the real object is hidden by the real object and is invisible to the user. In a case where the virtual object remains invisible for a long period of time, the user is not able to recognize the competitor, which will not contribute to improving the user's motivation by allowing the user to run while checking the competitor. For this reason, in S26, the portion of the virtual object that is hidden by the real object and is invisible is drawn differently from the portion of the virtual object that is visible. The different drawing is implemented, for example, by using different colors.

In Step S27, the virtual object and the auxiliary information object are output and projected onto the display unit of the HMD. Then, in Step S28, it is determined whether to end the program. In a case where the program is not ended (No), the process returns to just after S10. In a case where the program is ended (Yes), the process ends in S29.

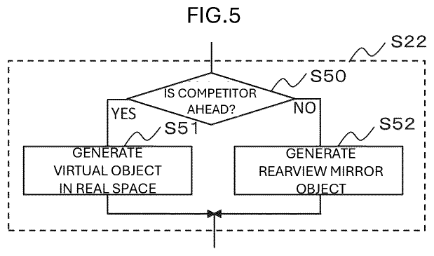

FIG. 5 is a flowchart illustrating the virtual object generation process (S22) in FIG. 4. In FIG. 5, in S50, it is determined whether the competitor is ahead of the user. In a case where the competitor is ahead of the user (YES), the virtual object is generated in the real space in S51. In a case where the competitor is not ahead of the user (NO), a rearview mirror object is generated, and the virtual object is disposed in the rearview mirror object in S52.

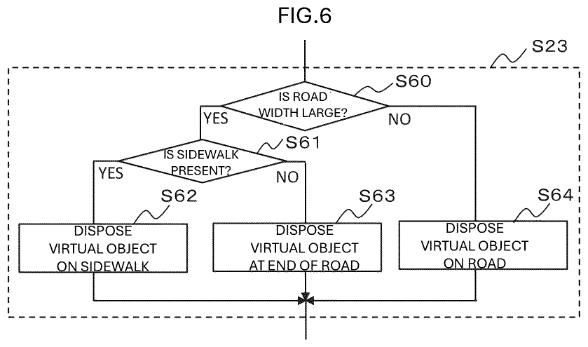

FIG. 6 is a flowchart illustrating the virtual object disposition process (S23) in FIG. 4. In FIG. 6, in S60, a road width is determined for the road element obtained as the extracted information from the map data. In a case where the road width is large (YES), it is further determined whether a sidewalk is present or absent in S61. In a case where the sidewalk is present (YES), the virtual object is disposed on the sidewalk in S62. In a case where the sidewalk is absent (NO), the virtual object is disposed at the end of the road in S63. In a case where it is determined in S60 that the road width is small (NO), the virtual object is disposed on the road in S64. In S62 to S64, the virtual object is disposed at a position corresponding to the running distance measured along the running course.

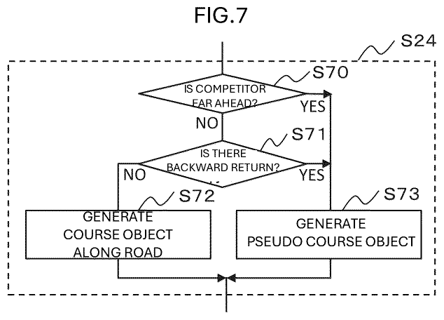

FIG. 7 is a flowchart illustrating the course object generation process (S25) in FIG. 4. In FIG. 7, in S70, it is determined whether the competitor is far ahead. In S71, it is determined whether or not the competitor is out of the viewing angle of the user because the course is set to return in a direction opposite to the running direction of the user. In a case where the competitor is within the viewing angle of the user (NO in both S70 and S71), a course object based on the road is generated in S72. In a case where the competitor is out of the viewing angle of the user (YES in either S70 or S71), a pseudo course object is created in S73. The pseudo course object is a course object in which only the sense of distance to the competitor has been reflected and which has no relation to the road in the real space.

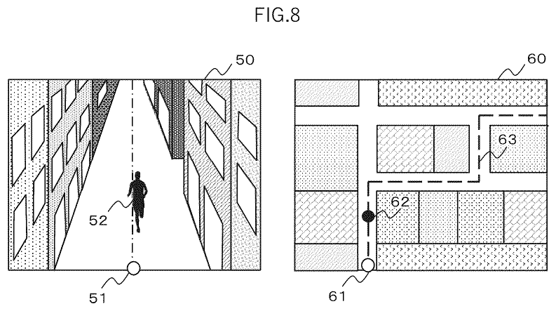

Next, a specific example of display according to this embodiment will be described with reference to FIGS. 8 to 12. FIG. 8 illustrates an example of display in a case where the competitor is ahead of the user and is visible without being hidden by the real object. In FIG. 8, the left side is a display image 50 of the HMD seen by the user, and the right side is a corresponding map 60. Furthermore, in FIGS. 8, 51 and 61 indicate the user, 52 and 62 indicate the competitor (a virtual object; and, in particular, 52 indicates an avatar), and 63 indicates a running course. On the left side of FIG. 8, the user 51 is not included in the display image 50, but is illustrated in order to refer to the position of the user. Further, the image of the competitor 52 is displayed as the virtual object.

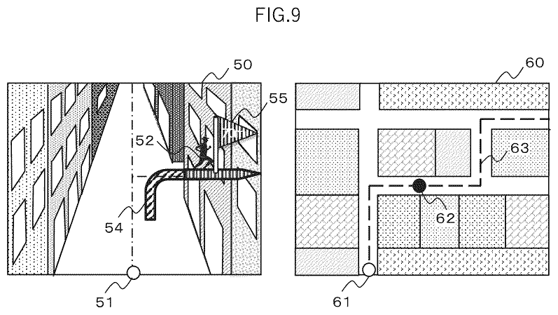

FIG. 9 illustrates an example of display in a case where the competitor is ahead of the user, but is hidden by a building, which is a real object, and is invisible. In FIG. 9, the same configurations as those in FIG. 8 are denoted by the same reference numerals, and a description thereof will be omitted. FIG. 9 differs from FIG. 8 in that a course object 54 and a distance information object 55, which are auxiliary information objects, are added.

On the left side of FIG. 9, the competitor 52, which is the virtual object, is hidden by the building, which is the real object, and is normally invisible. However, unlike the case of FIG. 8, for example, the display color of the competitor is changed, and the competitor is drawn in a different form such that the user does not lose sight of the competitor. In addition, the course object 54 is partially hidden by the building which is the real object, but the hidden portion is displayed in a different drawing form from the portion that is not hidden to guide the user along the running course. Further, the distance information object 55 is displayed to allow the user to obtain an accurate sense of distance.

As described above, the drawing form of the hidden portion of the virtual object that is the competitor is changed, or the running course is virtually displayed as the course object to change the drawing form of the hidden portion of the course object. Therefore, it is possible to enhance the sense of realism of the user and to help improve the performance of the runner.

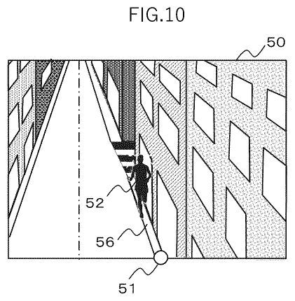

FIG. 10 illustrates an example in which the virtual object is disposed at a specific position. In FIG. 10, the same configurations as those in FIG. 8 are denoted by the same reference numerals, and a description thereof will be omitted. In FIG. 10, in a case where the road width of the running course is large and a sidewalk 56 is installed, the competitor 52 that is the virtual object is disposed on the sidewalk 56 such that the competitor 52 that is the virtual object does not overlap obstacles, such as cars, on a roadway.

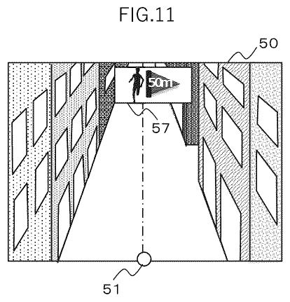

FIG. 11 illustrates an example of display in a case where the competitor is behind the user. In FIG. 11, the same configurations as those in FIG. 8 are denoted by the same reference numerals, and a description thereof will be omitted. In FIG. 11, a rearview mirror object 57 is displayed at a specific position, for example, in an upper portion of the display image 50 of the HMD. The virtual object of the competitor and the distance information object are displayed in the rearview mirror object 57, which makes it easy for the user to recognize that the competitor is behind the user.

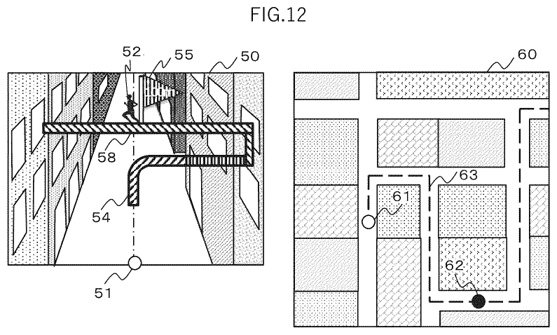

FIG. 12 illustrates an example of display in a case where the competitor is far ahead of the user or in a case where the running course is meandering as illustrated in the map on the right side of FIG. 12 and the competitor is out of the viewing angle of the user (the display range of the display image of the HMD), in other words, the virtual object is out of the visible range. In FIG. 12, the same configurations as those in FIG. 9 are denoted by the same reference numerals, and a description thereof will be omitted. As illustrated on the left side of FIG. 12, a pseudo course object 58 including the course object 54 is displayed, and the competitor 52 that is the virtual object, the distance information object 55, and the like are displayed on the pseudo course object 58. The pseudo course object 58 is a three-dimensional object using, for example, perspective which gradually moves away from the user 51. Then, the competitor 52 that is the virtual object is disposed at a position obtained by equivalently converting the distance that the competitor is ahead of the user on the pseudo course object 58 such that the distance when the user views the competitor is reflected in the actual distance. Therefore, the sense of real distance on the virtual course is improved, and it is possible to help improve the performance of the runner. In addition, only one of the pseudo course object 58 and the competitor 52 that is the virtual object may be displayed.

As described above, a virtual object display method according to this embodiment includes a display process, a position detection process, map information processing, virtual object processing, auxiliary information processing, and an image recognition process. The position detection process specifies the position of the user on the map, and the map information processing extracts a road and the like that are set in advance as the running course. The virtual object processing generates the virtual object such as the competitor. The virtual object is given a relative position with respect to the user and a disposition position of the virtual object on the running course. The image recognition process recognizes a real object from the image of the real space, and the display process determines whether the virtual object is within the visible range of the user and displays the virtual object outside the visible range in a form different from the virtual object within the visible range. In addition, the auxiliary information processing displays information of the running course or the like extracted by the map information processing as an auxiliary information object.

In addition, a virtual object display device according to this embodiment includes a display processing unit, a position detection processing unit, a map information processing unit, a virtual object processing unit, an auxiliary information processing unit, a camera unit, and an image recognition processing unit. The position detection processing unit specifies the position of the user on the map, and the map information processing unit extracts a road and the like that are set in advance as the running course. The virtual object processing unit generates a virtual object such as a competitor. The virtual object is given a relative position with respect to the user and a disposition position of the virtual object on the running course. The image recognition processing unit recognizes a real object from the image of the real space obtained by the camera, the and display processing unit determines whether the virtual object is within the visible range of the user and displays the virtual object outside the visible range in a form different from the virtual object within the visible range. In addition, the auxiliary information processing unit displays information of the running course or the like extracted by the map information processing as an auxiliary information object.

As described above, according to this embodiment, it is possible to provide a virtual object display device and a virtual object display method that can enhance the sense of realism of the user by changing a drawing form such that the user does not lose sight of a virtual object even in a case where the virtual object is invisible in an MR space in which a real space and a virtual space are merged. In addition, the virtual object outside the visible range is drawn as a pseudo object, which makes it possible to enhance the sense of realism of the user.

The embodiment has been described above. However, the present invention is not limited to the above-described embodiment and includes various modification examples. For example, the present invention is not necessarily limited to the technique having all of the configurations described in the embodiment. In addition, the virtual object display device may be a smartphone or a car navigation system other than the HMD.

In addition, in this embodiment, for example, the functions of the above-described embodiment have been described as being processed by software. However, some or all of the functions may be implemented by hardware. For example, some or all of the functions are designed as an integrated circuit. Further, the implementation range of software is not limited, and hardware and software may be used together. Furthermore, some or all of the functions may be implemented by a server. Moreover, the server may have any form as long as it can cooperate with other components via communication to implement the functions and is, for example, a local server, a cloud server, an edge server, a network service, or the like. In addition, information of programs, tables, files, and the like for implementing each function may be stored in a memory, a recording device, such as a hard disk or a solid state drive (SSD), or a recording medium, such as an IC card, an SD card, or a DVD, or may be stored in a device on a communication network.

Further, the programs described in each processing example may be independent programs, or a plurality of programs may constitute one application program. In addition, each process may be performed while changing the order in which each process is performed.

### REFERENCE SIGNS LIST

1, 2 HMD
10 Camera
11 Distance measurement sensor
12, 12a, 12b Projection unit
13 Screen
18, 18a, 18b Control unit
20 Image recognition processing unit
21, 30 Communication unit
22 Map information processing unit
23 Virtual object processing unit
24 Display processing unit
25 Position detection processing unit
26 Auxiliary information processing unit
27 Overall control unit
31 CPU
33 FROM
35 MR processing program
50 Display image
60 Map
51, 61 User
52 Competitor (virtual object)
62 Competitor
63 Running course
54 Course object
55 Distance information object
56 Sidewalk
57 Rearview mirror object
58 Pseudo course object

1. A virtual object display method comprising:
a map information processing step of extracting a first map element corresponding to position information and a second map element corresponding to a predetermined pattern from map data;
a virtual object processing step of disposing a virtual object on a real object in a real space corresponding to the first map element;
an auxiliary information processing step of generating a map element object corresponding to the second map element;
a display processing step of drawing portions, which are located in front of and behind the real object, in the virtual object and the map element object using different drawing methods; and
a display step of displaying the virtual object and the map element object processed in the display processing step to be superimposed on the real space.

2. The virtual object display method according to claim 1,
wherein the virtual object is a competitor in a virtual space,
the map element object is a course object, and
in the display step, the competitor and the course object are displayed to be superimposed on the real space.

3. The virtual object display method according to claim 2,
wherein the map element object includes a distance information object, and
in the display step, the competitor, the course object, and the distance information object are displayed to be superimposed on the real space.

4. The virtual object display method according to claim 1,
wherein the virtual object is a competitor in a virtual space,
the map element object is a distance information object, and
in the display step, the competitor and the distance information object are displayed to be superimposed on a specific position in the real space.

5. The virtual object display method according to claim 2,
wherein, in the auxiliary information processing step, a pseudo course object is generated as the map element object when the competitor is out of a display range of an image displayed in the display step, and
in the display step, the competitor is disposed on the pseudo course object, and a sense of distance to the competitor viewed by the user is displayed so as to correspond to a distance between the user and the competitor.

6. A visual object display device comprising:
a map information processing unit extracting a first map element corresponding to position information and a second map element corresponding to a predetermined pattern from map data;
a virtual object processing unit disposing a virtual object on a real object in a real space corresponding to the first map element;
an auxiliary information processing unit generating a map element object corresponding to the second map element; and
a display processing unit drawing portions, which are located in front of and behind the real object, in the virtual object and the map element object using different drawing methods and displaying the virtual object and the map element object drawn by the different drawing methods to be superimposed on the real space.

7. The virtual object display device according to claim 6,
wherein the virtual object is a competitor in a virtual space,
the map element object is a course object, and
the display processing unit displays the competitor and the course object to be superimposed on the real space.

8. The virtual object display device according to claim 7,
wherein the map element object includes a distance information object, and
the display processing unit displays the competitor, the course object, and the distance information object to be superimposed on the real space.

9. The virtual object display device according to claim 6,
wherein the virtual object is a competitor in a virtual space,
the map element object is a distance information object, and
the display processing unit displays the competitor and the distance information object to be superimposed on a specific position in the real space.

10. The virtual object display device according to claim 7,
wherein the auxiliary information processing unit generates a pseudo course object as the map element object when the competitor is out of a display range of an image displayed by the display processing unit, and
the display processing unit disposes the competitor on the pseudo course object and displays a sense of distance to the competitor viewed by the user so as to correspond to a distance between the user and the competitor.
